(19) United States
(12) Patent Application Publication
(10) Pub. No.: US 2009/0144183 A1
(43) Pub. Date: Jun. 4, 2009

(54) MANAGING USER ACCOUNTS FOR STORAGE DELIVERY NETWORK

(75) Inventors: Troy C. GATCHELL, San Diego, CA (US); Scott P. Chatley, San Diego, CA (US); Geoffrey T. Tudor, Austin, TX (US)

Correspondence Address: MORRISON & FOERSTER LLP, 12531 HIGH BLUFF DRIVE, SUITE 100, SAN DIEGO, CA, 92130-2040, US

(73) Assignee: Nirvanix, Inc., San Diego, CA (US)

(21) Appl. No.: 12/200,826

(22) Filed: Aug. 28, 2008

Related U.S. Application Data
(60) Provisional application No. 60/968,848, filed on Aug. 29, 2007.
(60) Provisional application No. 61/001,680, filed on Nov. 2, 2007.

(51) Int. Cl. G06Q 30/00; G06Q 50/00

(52) U.S. Cl. 705/34

(57) ABSTRACT

Disclosed herein are systems and methods for managing a plurality of unique account holders, each having dynamically controllable policies relating to storage, transfer bandwidth, file sizes, pricing options and the like. User accounts can be organized in a hierarchical structure, where an account in the hierarchical structure can manage any account beneath it. For example, a parent account can manage all of its child accounts. In one embodiment, tilling policies can be set by a parent account dictating whether its child account's usage of the system is billed to the parent account or the child account. Moreover, in one embodiment, policies set in an account are automatically inherited by all accounts beneath that account unless that account specifies otherwise.

### CROSS-REFERENCE TO RELATED APPLICATIONS

This application claims priority to U.S. Provisional Patent Application No. 60/968,848 filed Aug. 29, 2007, the content of which is incorporated by reference herein in its entirety.

This application claims priority to U.S. Provisional Patent Application No. 61/001,680 filed Nov. 2, 2007, the content of which is incorporated by reference herein in its entirety.

### FIELD OF THE INVENTION

The present invention relates generally to network communications, and more particularly to managing accounts of network file systems.

### BACKGROUND OF THE INVENTION

In computing, a file system can store and organize data files in order to make the data files easier to find and access. File systems may use a data storage device such as a hard disk or CD-ROM to maintain the physical location of computer files. A file system may provide access to data on a file server by acting as a client for a network protocol. In other words, file system can be a set of abstract data types that are implemented for the storage, hierarchical organization, manipulation, navigation, access, and retrieval of data.

A network file system is a file system that acts as a client for a remote file access protocol, providing access to files on a server. A network file system can be any computer file system that supports access of files over a computer network. A network file system may be distributed over clients, servers, and storage devices dispersed among the machines distributed in an intranet or over the internet. Service activity occurs across the network, and instead of a single centralized data repository, the system may have multiple and independent storage devices. In some network file systems, servers run on dedicated machines, while in others a machine can be both a server and a client. A network file system can be implemented as part of a distributed operating system, or by a software layer that manages the communication between conventional operating systems and file systems. A network file system may appear to its users to be a conventional, centralized file system. The multiplicity and dispersion of its servers and storage devices can be made invisible, and the client interface used by programs should not distinguish between local and remote files. It is up to the network file system to locate the files and to arrange for the transport of data.

A storage delivery network (SDN) may include a network file system that is used for scalable networking applications. SDNs can be composed of one or more computers with large data storage capacity, which serve files and media over a network.

### SUMMARY OF THE INVENTION

Embodiments of the present invention relate to a standards-based API web service that integrates user account storage into any online application. Various embodiments enable end-users to create accounts and set storage, bandwidth, expiration dates and other limits on those accounts.

In accordance with various embodiments, a web service platform integrates a plurality of user account management functions and presents these functions as simple-to-integrate APIs to web application developers.

In accordance with one embodiment, systems and methods are provided for creating sub-accounts of end-user accounts each with their own programmable end-user storage and bandwidth enforcement.

In accordance with one embodiment, systems and methods are provided for end-user storage services made available via web programming interface that provides strict end-user storage and bandwidth enforcement.

In accordance with one embodiment, systems and methods are provided for designating account expiration windows based on a predetermined period of time limit, where upon expiration of the predetermined amount of time, the user's account and all contents therein are marked off-line. Further, after the expiration of a second predetermined time limit, user data and files stored in user's account are deleted.

### BRIEF DESCRIPTION OF THE DRAWINGS

The present disclosure, in accordance with one or more embodiments, is described in detail with reference to the following figures. The drawings are provided for purposes of illustration only and merely depict typical or exemplary embodiments of the disclosure. These drawings are provided to facilitate the reader's understanding of the disclosure and shall not be considered limiting of the breadth, scope, or applicability of the disclosure. It should be noted that for clarity and ease of illustration these drawings are not necessarily made to scale.

FIG. 1 illustrates an exemplary storage delivery network (SDN) system in accordance with one embodiment of the invention.

FIG. 2 illustrates a block diagram of an SDN in accordance with one embodiment of the invention.

FIG. 3 illustrates a hierarchical tree structure of accounts in accordance with one embodiment of the invention.

FIG. 4 illustrates relationships between components of an account management subsystem in accordance with one embodiment of the invention.

FIG. 5 illustrates a master account creation process in accordance with one embodiment of the invention.

FIG. 6 illustrates a child account creation process in accordance with one embodiment of the invention.

### DETAILED DESCRIPTION OF THE EXEMPLARY EMBODIMENTS

Embodiments of the present invention are directed toward systems and methods for managing a plurality of unique account holders, each having dynamically controllable policies relating to storage, transfer bandwidth, file sizes, pricing options and the like. User accounts can be organized in a hierarchical structure, where an account in the hierarchical structure can manage any account beneath it. For example, a parent account can manage all of its child accounts. In one embodiment, tilling policies can be set by a parent account dictating whether its child account's usage of the system is billed to the parent account or the child account. Moreover, in one embodiment, policies set in an account are automatically inherited by all accounts beneath that account unless that account specifies otherwise.

Before describing embodiments of the present invention in further detail, it is useful to describe an exemplary environment in which embodiments of the present invention can be implemented. One such exemplary environment is a storage delivery network (SDN) system that enables users to store, retrieve, and manipulate files from a remote location using a rich set of Web Service application programming interfaces (APIs). From time-to-time, embodiments of the present invention are described herein in terms of this exemplary environment.

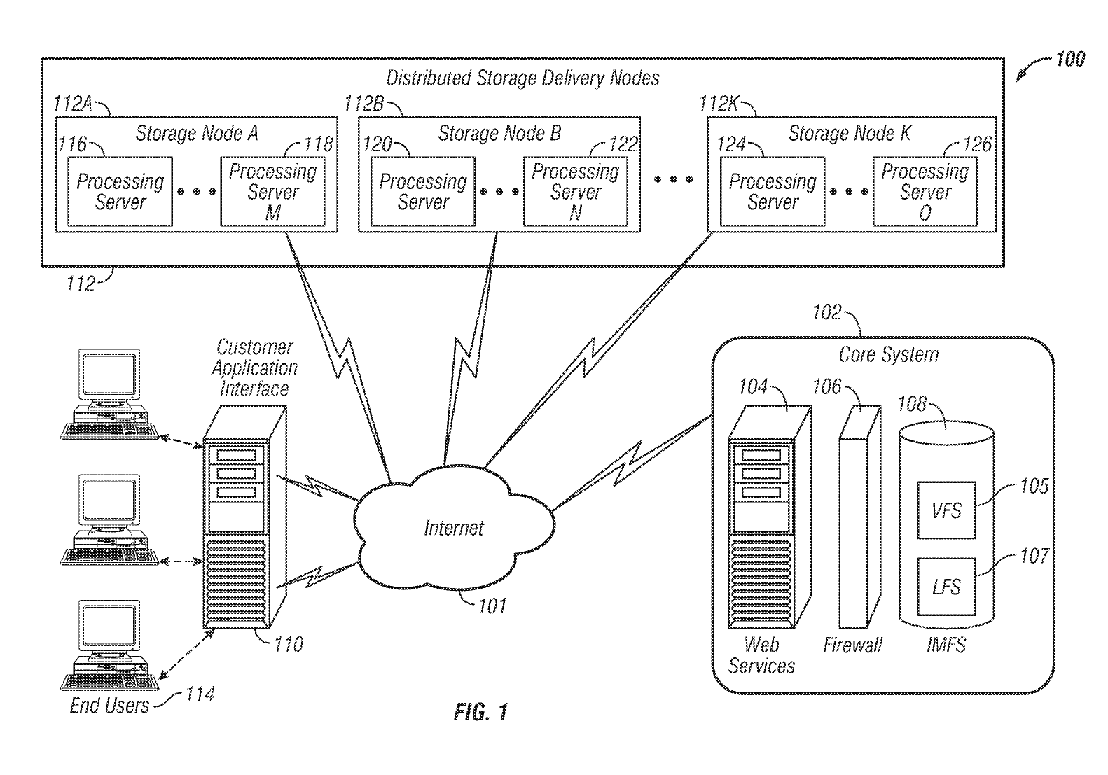

FIG. 1 illustrates an exemplary SDN system 100 in accordance with one embodiment of the invention. The SDN system 100 may comprise a core system 102, which may control one or more distributed storage delivery nodes 112A, 112BB-112K. The SDN system 100 may also comprise a customer application interface 110, which may serve a plurality of end users 114. The core system 102, the distributed storage delivery nodes 112A, 112B-112K, and the customer application interface 110 can communicate via a communication network such as the Internet 101.

The core system 102 may comprise a web services server 104, a firewall server 106, and an Internet media file system (IMFS) 108. It is understood that the core system 102 may comprise any number of servers (e.g., the web services server 104, firewall server 106) for performing its tasks and operations described herein. In addition, the various functionalities and operations described herein may be consolidated into a fewer number of servers or processors, or distributed among a larger number of servers or processors, as desired in accordance with network requirements.

The web services server 104 may accept requests from end users 114 (e.g., via customer application interface 110) related to accessing, storing and manipulating files stored on the SDN system 100. The web services server 104 may also redirect end users 114 to appropriate storage delivery nodes 112 during uploading and downloading of media files, for example.

The firewall server 106 provides a software application, which inspects network traffic passing through the web services server 104, and permits or denies passage based on a set of rules. A firewall's basic task is to regulate some of the flow of traffic between computer networks of different trust levels. Typical examples are the Internet which is a zone with no trust and an internal network which is a zone of higher trust. A firewall's function within a network is to prevent unauthorized or unwanted network intrusion to the private network.

In accordance with one embodiment, the IMFS 108 includes a computer database and computer programs that provide file system services to the web services server 104. In one embodiment, the IMFS 108 includes a virtual file system (VFS) 105, and a logical file system (LFS) 107. The IMFS 108 may organize the storage of data using a database structure, such as a relational database structure. Examples of other database structures that may be used are hierarchical database and object oriented database structures. Database management systems may be included in the IMFS 108 to organize and maintain the database. The IMFS 108 may also comprise a computer or computers dedicated to running the IMFS 108.

In one embodiment, the core system 102 communicates with a customer application interface 110 via the Internet 101 in accordance with a web services protocol (e.g., Simple Object Access Protocol (SOAP) or Representational State Transfer (REST)). The customer application interface 110 provides requested files (e.g., music or video files) and services (e.g., video streaming) to a plurality of end users 114 who have purchased or subscribed to the customer application interface. In various embodiments, the customer application interface 110 can be a hosted website on a server, or an application running on a personal computer or other computing device (e.g., a mobile phone or personal digital assistant (PDA)).

With further reference to FIG. 1, physical end user files are stored in physical file storage (PFS) distributed across storage delivery nodes 112A, 112B-112K. Each distributed storage delivery node 112A, 112B-112K may include a plurality of processing servers 1-M, 1-N and 1-O respectively (where A, B and K, and M, N and O can be any positive integer value). In one embodiment, each distributed storage delivery node 112A, 112B-112K has a node manager database server, a transfer server for handling uploading and downloading of files, one or more processing servers for processing the files, and one or more storage servers for storing files after they have been processed. An exemplary storage delivery node 112 is explained in more detail below with reference to FIG. 7.

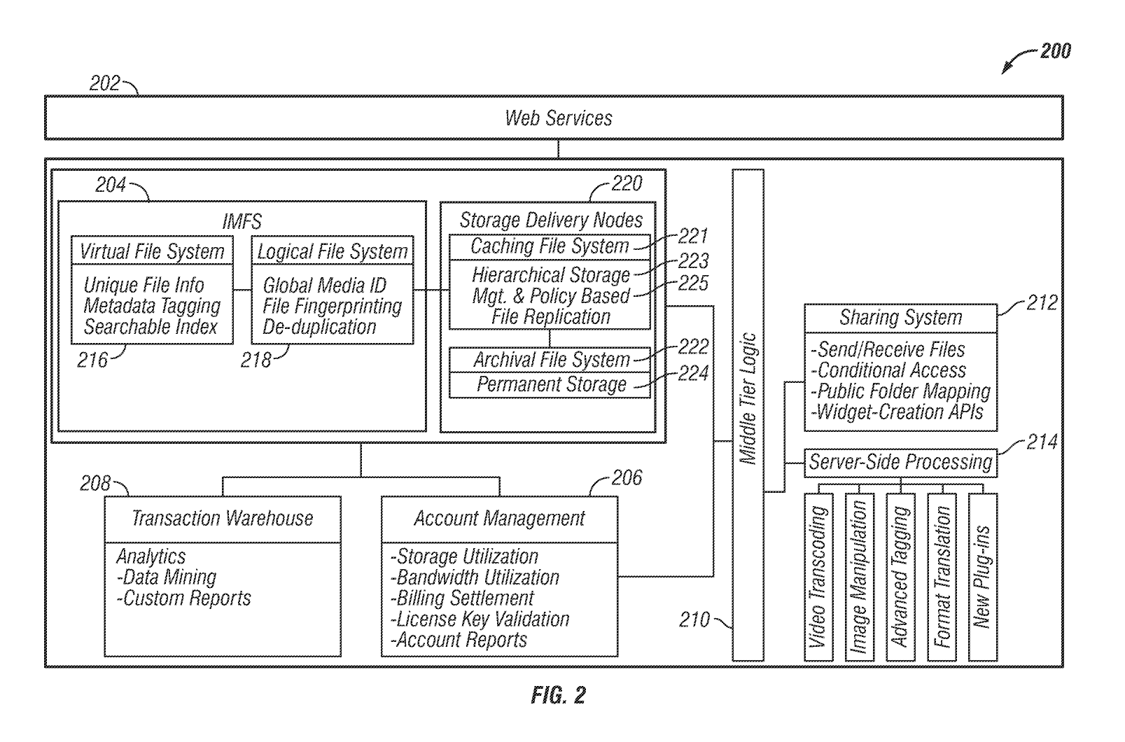

FIG. 2 illustrates an exemplary block diagram of an SDN system 200 in accordance with one embodiment of the invention. Various elements of SDN system 200 may be identical or similar to elements of SDN system 100 of FIG. 1. SDN system 200 includes a web services subsystem 202, an IMFS 204 (similar to IMFS 108 in FIG. 1), distributed storage delivery nodes 220 (similar to storage delivery nodes 112A, 112BB-112K of FIG. 1), an account management subsystem 206, and a transaction warehouse/analytics subsystem 208. SDN system 200 may also comprise middle tier logic 210 coupled to the IMFS 204, storage delivery nodes 220, and the account management subsystem 206. SDN system 200 further includes a sharing engine subsystem 212 and server side processing applications 214. Each of these systems and applications are described in further detail below.

The web services subsystem 202 can provide an application program interface (API) to end users 114 (FIG. 1) via the Internet 101. In exemplary embodiments, the web services subsystem 202 operates industry standard REST and/or SOAP protocols allowing end users 114 to upload, copy, move and delete files and folders. Furthermore, end users 114 can retrieve a listing of their files stored in SDN system 200 and associated user defined tags and metadata. In one embodiment, the web services subsystem 202 presents the end user 114 with a tree-structured file system allowing the end users 114 to store and access files in a familiar fashion. In one embodiment, the file system is presented to the end user as a virtual hard drive on the end user's computing device. Communications between the end users 114 and core system 102 servers (FIG. 1) can use the Hypertext Transfer Protocol over Secure Socket Layer (HTTPS) protocol.

With further reference to FIG. 2, the IMFS 204 can include a Virtual File System (VFS) 216 and a Logical File System (LFS) 218 for managing files stored on the SDN system 200.

The VFS 216 can function as an abstraction layer on top of one or more conventional file systems to provide a uniform interface that is used to access data or files from one or more storage locations via a communications network. For example, VFS 216 can be an abstraction of a physical file storage system implementation, providing a consistent interface to multiple file and/or storage systems, both local and remote. In other words, the VFS 216 can allow end users 114 to access different types of file or file systems in a uniform way. The VFS 216 can, for example, be used to access local and remote network storage devices transparently without the client application noticing the difference. Additionally, in one embodiment, the VFS 216 can be used to bridge the differences in various types of file systems, so that client applications can access files on local or remote file systems without having to know what type of file systems directly control access to those files. Thus, the consistent interface provided by VFS 216 can allow the end users 114 to uniformly interface with a number of diverse file system types.

The VFS 216 stores end user information and controls end user directory structures (e.g., a tree structure) presented to end users 114 accessing files stored in SDN system 200. Directory structures can be presented to the end users 114 via the web services subsystem 202. As will be explained in further detail below, the VFS 216 includes a database that stores tables populated with information related to user files stored on the SDN system 200. For example, these tables can be populated by user folder names (e.g., “Scott's music”), user assigned file names (i.e., virtual file name), user overridden metadata, directory and/or path information, as well as virtual file identification (VFID) values associated with stored files. The VFID can be used to correlate each virtual file name with logical file and/or physical file information.

The LFS 218 provides an application with a consistent view of what can be, for example, multiple physical file systems and multiple file system implementations. In one embodiment, file system types, whether local, remote, or strictly logical, and regardless of implementation, are indistinguishable for applications using LFS 218. A consistent view of file system implementations is made possible by the VFS 216 abstraction. The VFS 216 abstraction specifies a set of file system operations that an implementation includes in order to carry out LFS 218 requests. Physical file systems can differ in how they implement these predefined operations, but they present a uniform interface to the LFS 218.

The LFS 218 stores information about files stored on SDN system 200, such as a media key (e.g., hash key), metadata, file size, file type, and the like. The LFS 218 also stores a logical file identification (LFID) value that is used to correlate or link a corresponding VFID with one or more physical files located in the distributed storage delivery nodes 112A, 112B-112K (FIG. 1). Thus, the LFS 218 acts as an intermediate layer that correlates the virtual layer with the physical layer. It is appreciated that many VFIDs may correspond to a single LFID, which in turn may correspond to one-to-many physical files distributed in various geographically distributed storage delivery nodes 112A, 112B-112K. For example, if multiple users have uploaded into their directory a song (e.g., “Wish You Were Here” by Pink Floyd), then multiple VFID's corresponding to the respective multiple user songs may be correlated to a single LFID that identifies the common song. This single LFID may then be linked (e.g., via SQL relational database tables) to one or more physical files. For redundancy or access performance reasons, multiple physical files corresponding to the song may be stored in more than one storage server. However, it is not necessary to store a physical file for each user. Multiple users can share access to a single physical file. In this way, the SDN system 200 allows de-duplication of files, thereby saving a considerable amount of storage real estate.

The distributed storage delivery nodes 220 (similar to 112A, 112B-112K in FIG. 1) comprise optional archival file storage (AFS) 222, permanent file storage 224. The distributed storage delivery nodes 220 include physical file storage devices such as one or more hard drives. The AFS 222 may archive files, including compressed versions of files stored on or previously stored on the permanent file storage 224. Each storage delivery node 220 also stores one or more tables (e.g., relational database tables) populated by information indicating where files are stored within the respective storage delivery node. The tables may also be populated with path information for each file stored in the distributed storage delivery node 220, and information correlating each file with a logical file identification value (LFID).

Further to FIG. 2, the storage delivery nodes 220 can also include a cache file system 221, a hierarchical storage system 223 and a management and policy-based file replication system 225. The cache file system may be used to temporarily store data before it is stored in a more permanent type of memory storage system. The hierarchical database may be used to manage how data is stored in a hierarchical fashion. The management and policy-based file replication system may be used for managing how many copies of each file are to be stored and whether copies of the files should be stored on high availability storage or archive storage, for example.

The SDN system 200 can also comprise an account management subsystem 206 that manages accounts for end users 114 and/or customers that have an account to access and use the SDN system 200. A customer may be, without limitation, a content and/or application provider. The account management subsystem 206 can, for example, control who can access certain applications and/or content, track usage, and calculate prices and payment data in accordance with a customer's service level agreement (SLA).

An SLA can be an agreement between one or more users and an SDN system administrator or customer, which provides a client interface application to the one or more users. The SLA specifies a level of service (e.g., quality of services, storage and access rights and preferences, etc.) to be provided to the users.

The transaction warehouse 208 can store archival information regarding transactions performed within the VFS 216, including billing, payment history and file operations. This allows for reporting information to be gathered historically.

The middle tier logic 210 does string validation and prepackages user-inputted data for entry into the IMFS 204. As data is returned from the IMFS 204, the middle tier logic 210 un-packages it for serialization and presentation to the end users 114. In one embodiment, end users 114 need not issue commands directly to the IMFS 204; rather, end user inputs are parsed and transmitted to the IMFS 204 via the middle tier 210. Data returned from the IMFS 204 may go through this same middle tier logic 210. This provides for additional security and command validation prior to entry into the SDN system 200.

In addition to providing secured access to uploaded files, users of the IMFS 204 may have the option of allowing access to individual virtual folders and files to other users. This is accomplished through the sharing subsystem 212 which can be directly correlated to the VFS 216. In this manner, once a user has sent the IMFS 204 a sharing command, a separate entry is created within the VFS 216 linked to the original record. Creation of the entry in the VFS 216 allows the end users 114 to share the file or folder using a different name for the file or folder, but without duplicating the file or folder. End users 114 see the virtual file or folder, and the VFS 216 provides the connection to the original file of folder. Additionally, access restrictions (by IP, password, and so on) can be added to a shared resource, allowing granular control over whom the user is granting access to. Sharing subsystem 212 may also perform public folder mapping functions and functions related to widget creation for APIs.

Uploaded files are processed into the VFS 216 and LFS 218 via a custom file system command processor service. The command processor service can be performed by command processing servers 214, which can determine the uniqueness of each file and perform transcode services as determined by a controlling SLA. Command processing servers 214 can also be used for processing new plug-ins, format translation, advanced tagging, image manipulation and video transcoding.

Having thus described exemplary environments in which embodiments of the present invention may be implemented, various features and embodiments of the present invention are now described in further detail. Description may be provided in terms of these exemplary environments for ease of discussion and understanding. After reading the description herein, it will become apparent to one of ordinary skill in the art that the present invention can be implemented in any number of different environments.

As described above with reference to FIG. 2, the SDN system 200 includes an account management subsystem 206 that manages accounts for end users 114 and/or customers that have an account to access and use the SDN system 200. The accounting management subsystem 206 may include three tiers of accounts comprised of master accounts, parent accounts, and child accounts. The master account may control access to SDN system 200 for the master account's applications and sub-accounts (e.g., parent accounts and child accounts) associated with those applications. For each application, the master account may have a directly associated parent account which grants access to an IMFS path (folder and file storage locations) within said application. This allows the master account to test functionality and have its own SDN storage space. Each parent account can control access and limits for all of its child accounts via a hierarchal structure (e.g., tree structure).

In accordance with one embodiment, master accounts may be used to administer, create and edit applications, gather usage statistics, and set usage limits. For example, a master account can set policies and limits for each of its sub-accounts. In one embodiment, all policies and limits are inherited by further sub-accounts, unless the master account dictates otherwise. Master accounts may also have billing accounting functionality, as described in more detail below.

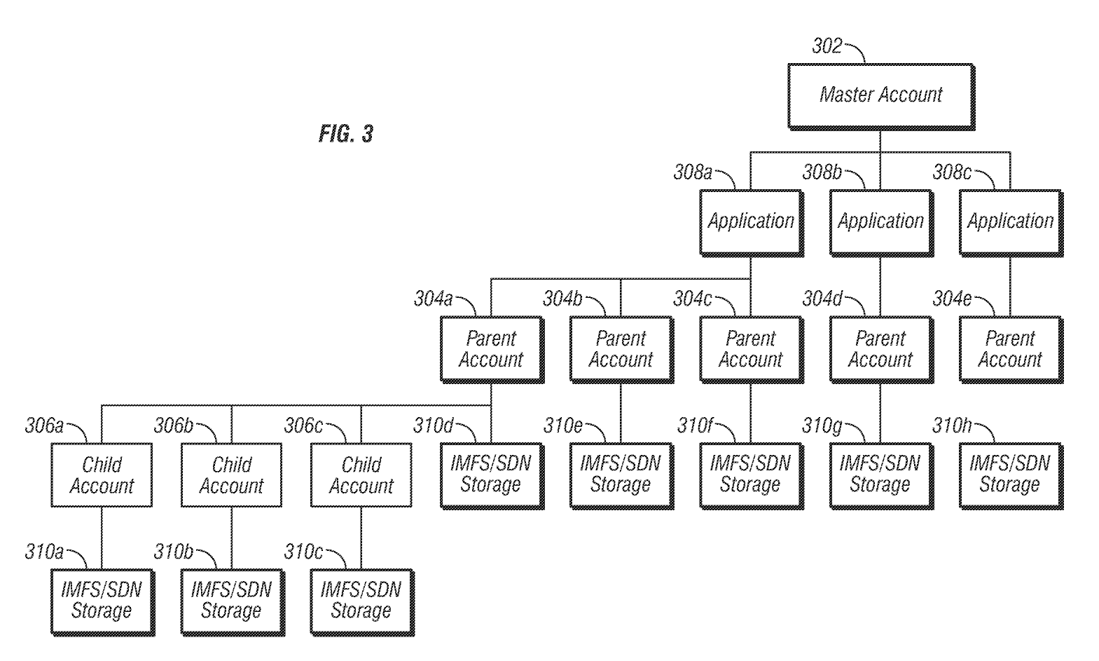

FIG. 3 is a diagram illustrating an exemplary hierarchical tree structure of accounts in accordance with one embodiment. The illustrated hierarchical tree structure comprises three levels of accounts: a master account 302, parent accounts 304a-304e and child accounts 306a-306c. Each account level may be stored in a table in a relational database in a hierarchical tree format. As illustrated, master account 302 relates to application 308 on a many-to-many relationship to allow several users administration functions over various applications within the SDN. Each application 308 relates to accounts on a one-to-many model. The accounts may also self-relate on a one-to-many, such that any account which has a direct relationship to an application 308a-308c may be considered a parent account 304 and any account which relates to another account is considered a child account 306. It can be noted that child accounts may also be parent accounts themselves, extending the hierarchy further and to multiple limitless account levels within the hierarchical tree.

The master account 302 may have an allocated amount of storage space, which may be allocated to its parent accounts 304. Each parent account 304 may then allocate its storage space to its child accounts. Thus, in the example illustrated in FIG. 3, master account 302 can allocate storage space allocated to parent account 304a. The parent account 304a may divide the storage space allocated to it between its three child accounts 306a, 306b and 306c. Accordingly, each account located at a bottom of the hierarchical structure of FIG. 3 can have its own allocated SDN storage space 310.

In accordance with one embodiment, accounts contained within the master account's hierarchical structure may be permitted access and manipulate any account that is beneath them within the hierarchical structure. In other words, master account 302 can act upon applications 308a-308c, parent accounts 304a-304e, child accounts 306a-306c, and any further sub-accounts that may exists under the master account 302, such as grand child accounts (not shown).

The master account 302 can also set policies governing any account beneath it. In one embodiment, policies the master account 302 sets for a parent account 304 are automatically inherited by each of the child accounts 306 and any further sub-accounts that may exist under the parent account 304. In this manner, a master account 302 can manage the accounts beneath it in the hierarchical structure without having to set policies each time a new account it created. In addition, the master account 302 can modify any of the inherited policies of a specific account if needed.

In one embodiment, account-to-account relationships can be related using a relational database table having a “ParentAccountID” column. For example, a zero value in an account's ParentAccountID column and an account type of parent account indicates that the account has a direct relationship with an application, and is therefore considered a parent account.

The account management subsystem 206 (FIG. 2) may include an API that allows users to add accounts to a hierarchal database that links child accounts to parent accounts. Parent accounts can control limits on their children by, for example, setting storage usage, transfer bandwidth, and file size limits. These limits can be reset via time expiration (years, months, days, hours, etc) through the API and a background daemon process. This gives parent accounts control of child account usage.

In one embodiment, the parent-to-child relationship allows parents accounts an option to act on behalf of their child accounts. In addition, actions taken by a parent account on behalf of their child accounts may be recorded and billed to the parent account or to the child account according to a billing policy set by the parent account. For example, the parent account can set a billing policy that dictates that all usage of the child accounts be billed to the parent account. As another example, the parent account can set a billing policy that dictates that each child account be billed for its own usage and that the parent account not be billed for any of its child accounts' usage. Moreover, the parent account can set a billing policy that dictates that some types of usage its child account be billed to the parent account and other types of usage of its child account be billed to that child account.

The account management subsystem 206 may also include an API interface that allows parent accounts to create child account contact information and extensible markup language (XML) based account notes. Furthermore, the API interface allows non-standard contact information to be stored in XML format. The API allows parent accounts to set account statuses on their children, such as disabled, enabled, expired, or deleted. An expiration limit on a child account can be set using a time frame or specific date in which the child account will expire. A background daemon process may monitor the SDN system 200 for the purpose of expiring child accounts based on how the child account is configured (e.g., a predefined expiration date has passed).

The account management subsystem 206 may further include a reporting API that allows parent accounts the ability to retrieve real time data on child account activity for storage, transfer bandwidth, and web service usage.

In accordance with one embodiment, master accounts are dynamically assigned a plan management ID based on automated sign-up process. Using the plan management ID, the account management subsystem 206 may provide dynamic pricing on storage, transfer bandwidth, and web service calls for each master account. In one embodiment, one plan management ID may have a set of features different from the features associated with an alternate plan management ID. In a further embodiment, all child accounts storage, transfer, and web service call(s) usage are rolled up on daily basis and cost is automatically calculated based on their plan management configuration.

Account management subsystem 206 may also provide the ability to customize plans and have database driven limits and billing algorithms for any account within the SDN 200. Billing algorithms may be dynamically driven for SDN features, including storage, transfer bandwidth, SDN search, and media operations. Media operations may include Image Resize, Image Rotation, Video Frame Extraction, Audio and Video Transcoding. Below are exemplary dynamically driven media operation algorithms (1)-(6) with rates customizable for accounts using plan management features of the account management subsystem 206:

(1) Video Frame Extraction Cost=(OFS*R)+(VFC*VFS*R2)+(VFS*R3)+CR

(2) Video Transcoding Cost=(OFS*R)+CR

(3) Audio Transcoding Cost=(OFS*R)+CR

(4) Image Resize Cost=(OFS*R)+CR

(5) Image Rotate/Flip Cost=(OFS*R)+CR

(6) Transcoding Profiles Cost=(OFS*R)+(NFS*R2)+CR

Where OFS is an original frame size; NFS is a new file size; VFC is a video frame count; VFS is a video frame size; CR is a per-call rate; and R, R and R3 are predetermined rates.

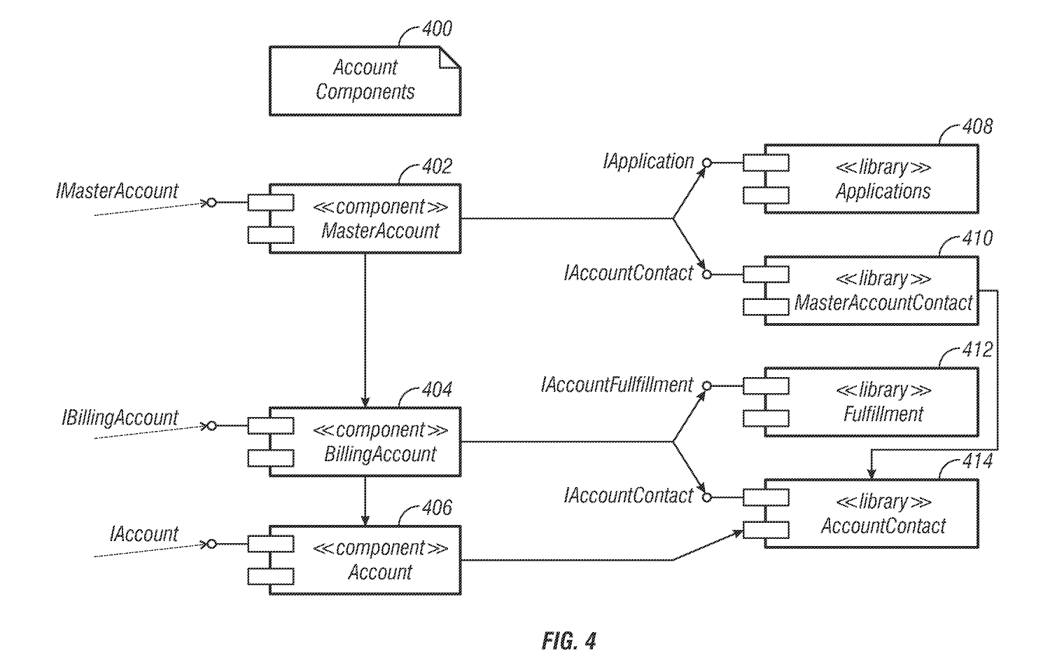

FIG. 4 illustrates relationships between account components 400 to create and manage accounts in accordance with one embodiment. There are three points of access to the account components. The master account component 402 implements the billing account component 404. Because the billing account component 404 implements the account component 406, the master account 402 has the same functionality available to it as the other two components. The master account component 402 maintains a list of applications 408 and master account contacts 410. The master account 402 uses the payment fulfillment 412 through its inheritance relationship with the billing account component 404. Billing account 404 and account component 406 use the account contacts 414.

The master account may be used as a primary contact point for a customer using the SDN system 200. The master account can control the organization and price-point for the applications the customer wishes to support. A master account has tools to configure all child accounts at the same time, or allows custom settings tailored to each individual child account. The master account can also view use statistics pertaining to its accounts.

One aspect of the account component is to allow a master account to administrate its children. Child accounts can be created and deleted. Their limits can be defined and reviewed. Their usage can be tracked. The master account is given the tools needed to control their customers.

In one embodiment, all of the exposed commands require a parent account to be logged in with the session token. Child accounts cannot view or change their own settings directly through the web services.

In accordance with one embodiment, the account component need not be always be used during IMFS account operations. Instead, these operations can be performed using an Account ID and an Application Key ID. The commands are sent to the IMFS Libraries, and do not need any additional abilities that the account component provides. In one embodiment, the account component is only used to analyze usage and other administrative tasks.

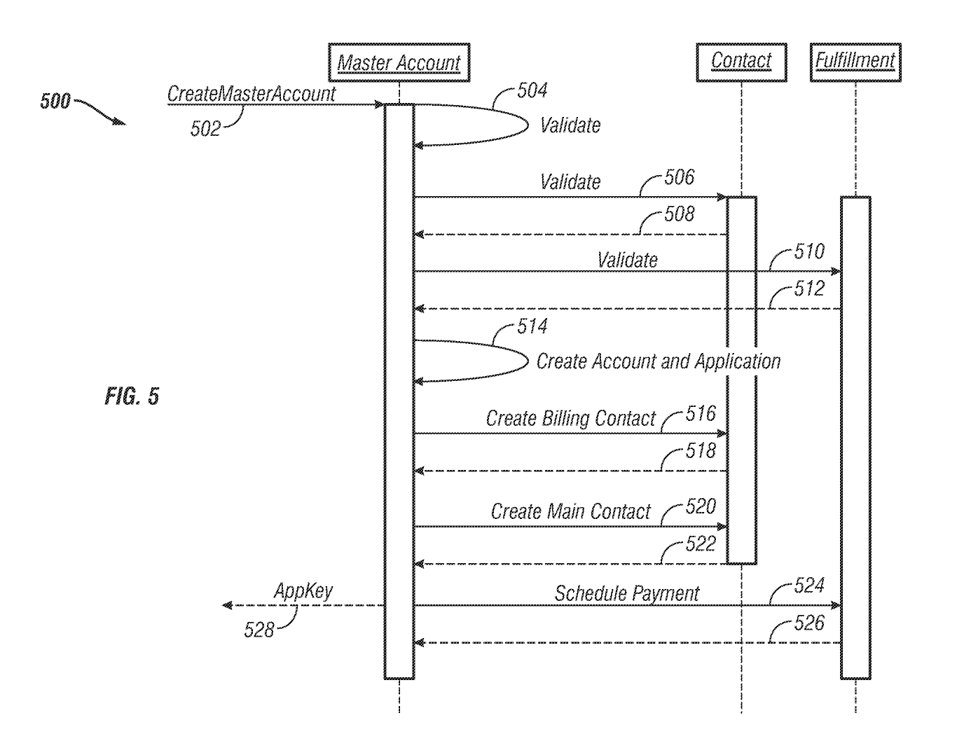

FIG. 5 illustrates a master account creation process 500 in accordance with one embodiment. The various tasks performed in connection with process 500 may be implemented by software, hardware, firmware, a computer-readable medium storing computer executable instructions for performing the process method, or any combination thereof. It should be appreciated that process 500 may include any number of additional or alternative tasks. The tasks shown in FIG. 5 need not be performed in the illustrated order, and process 500 may be incorporated into a more comprehensive procedure or process having additional functionality not described in detail herein. For illustrative purposes, the following description of process 500 may refer to elements mentioned above in connection with FIGS. 1-4.

The master account creation process 500 allows self-service creation of a new master accounts. In one embodiment, all that a user needs to set up a master account is a credit card or online payment account (e.g., PayPal) connected email address. All of the information in a request is first verified at steps 504 through 512. If the information passes validation, the information is sent used create a master account record, a main contact, and billing contact at steps 514 through 522. Payment information is then sent to payment the fulfillment component to schedule the billing cycle at steps 524 and 526. If everything is successful, a new master account is returned with a new application key at step 528.

In accordance with one embodiment, the following exemplary commands may be used during the master account creation process 500:
A command referred to as “CreateApplication” creates new applications. The fields required to make an application are passed in, and a new application key is returned.
A command referred to as “EditApplication” changes an existing application. The fields in an application are passed in, and a status code is returned. The SLA cannot be changed.
A command referred to as “RegenerateAppKey” creates a new Application Key for an existing application. The current application key is sent in, and a new application key is returned. The original application key is no longer valid.
A command referred to as “DeleteApplication” deletes an existing application. The current application key is sent in, and response code is returned. The application must not have any child accounts to be deleted.
A command referred to as “GetApplicationList” describes all existing applications for a master account. This returns an application key, name, and description of all applications of the master account.

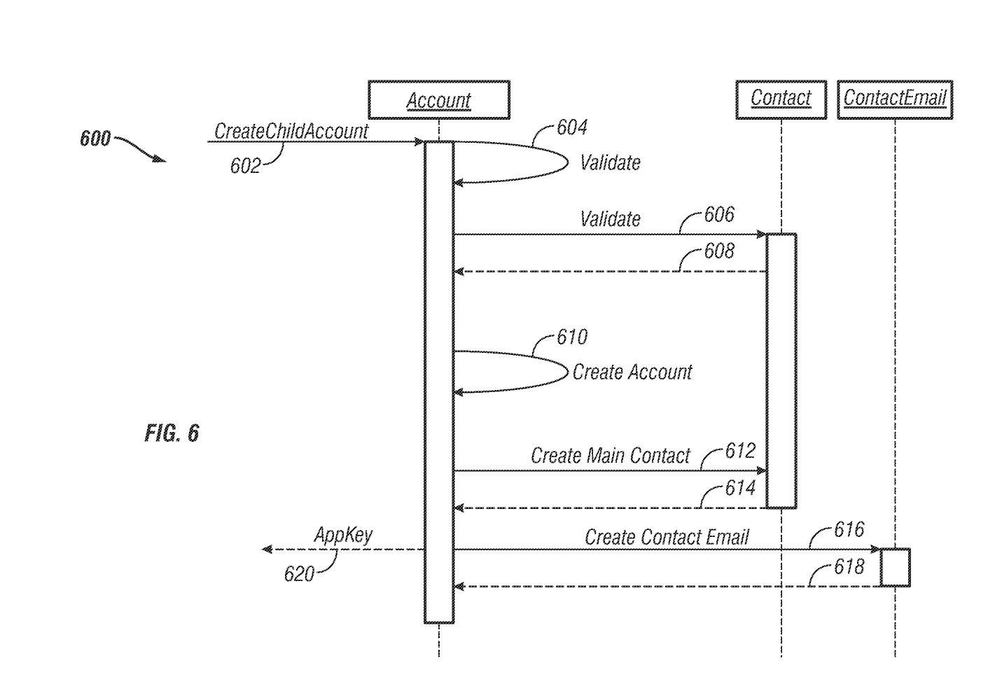

FIG. 6 illustrates a child account creation process 600 in accordance with one embodiment. Similar to the master account creation process 500, the child account creation process 600 can spans several components. At step 602, a request to create a child account is received at the account component. The account and contact information are first verified at steps 604 through 608. If the values pass validation, a child account record, a main contact, and an email contact for the main contact are created at steps 610 through 618. A response code is returned after successful completion at step 620.

The accounts component sets and retrieves limits for accounts. These settings control the access to a user's files. The accounts component exposes the commands that allow a master account to create child accounts, and set and read each child account's limits. The following are exemplary commands used to create child accounts and set and read their limits in accordance with one embodiment.

A command referred to as a “CreateChildAccount” creates a child account with a provided username, password, and contact info under a specific application key. A provided session token must be from the parent account login and the application key provided must be from an application owned by that parent account. The username must be unique under the application key provided. This command may be exposed as a web service. Exposed as a web service can refer to performing the command using a graphical user interface or making a call into an API.

A command referred to as “DeleteChildAccount” deletes the child account with the provided username, under a specific application key. The provided session token must be from the parent account login and the application key provided must be from an application owned by that parent account. The username must be under the application key provided. If the username exists under the application key, it will be deleted. A response code may be returned. This command may be exposed as a web service.

A command referred to as “GetUsage” returns all usage metrics for the provided username associated with the provided application key. A response code is returned, as well as a list of usage. This command may be exposed as a web service.

A command referred to as “GetLimits” returns all for the provided username under the provided application key. The session token must belong to a parent account associated with the username. A response code may be returned, as well as a list of the limits. This command may be exposed as a web service.

A command referred to as “SetLimits” sets the limits for the provided username under the provided application key. The session token must belong to a parent account for the username. A response code may be returned. This command may be exposed as a web service.

A command referred to as “GetAccountInfo” gets account details for the provided username under the provided application key. This includes contact information, current charges summary, billing information, and current system use. The session token must belong to the username, or a parent account of the username. A response code may be returned, as well as a list of information. This command may be exposed as a web service.

A command referred to as “SetAccountInfo” changes the account details for the provided username under the provided application key. This includes contact information, and billing information. The session token must belong to a parent account of the username. A response code may be returned. This command may be exposed as a web service. If a parameter is not passed or is null, the value will not be changed.

An accounting fulfillment interface may be used as a fulfillment/billing system. The accounting fulfillment interface can be used as a replacement of a billing system and allows use of mock objects in place of third party billing entities.

A customer can call into a finances interface to create or update billing information. The billing information can be updated or child customers can be updated to include the billing information.

The contact information will be retrieved from a database billing contact. The other billing info will be retrieved from a call to finances interface directly via a web service.

An unpublished web service call will be available to finances interface over a secure connection. This web service will be used to receive updates for plan and account changes. The changes may occur when an event occurs at finances interface and may update appropriate databases with this change.

Creation of accounts will be supported under the master account creation process 500 discussed above with reference to FIG. 5. Process 500 can also collect billing information and pass it to the finances interface web services to create a new account.

For example, when calling a CreateMasterAccount command, a pre-auth charge may be performed through a Finances Interface transaction. The results of this transaction may be returned to generate an Application Key if there was no error.

The billing information can be updated through a SetBillingInfo command. The SetBillingInfo command can communicate with the account object to save the new database information passed in, such as contact information, and communicates the billing information to Finances Interface directly without saving to the database.

All child accounts can be rolled up to the parent by adding and summing usage by combining total usage and the SLA Feature dollar amounts to get a parent total. This is accomplished using an AccountTransaction command to do AddUsage passing in each parent to Finances Interface for billing on a monthly basis. The daily usage sent is the average daily balance.

After creation of a standard child account the SetBillingInfo method can be called to turn the child into a billable account. Finances Interface will be called to set a plan for this child account causing Finances Interface to collect a monthly charge or to charge based on accrued usage. The Usage will be sent to Finances Interface through a call to Transaction.SetUsage, since the child is billable and has a billing type of Usage.

Various plans can be created to represent the prices for the subscription model. Changes to the plan will be sent as a call to the Finances Interface provisioning web service. If there is a failure in billing a subscription or usage child account the Finances Interface Provisioning call will be made to update the child account status.

The Finances Interface account will be deleted through the Finances Interface web services if the account has been expired.

Every billing period, if the billing fails, Finances Interface will call the provisioning web service to update the account status, keeping a history of failures in the database.

CreateMasterAccount can save billing information such as billing contact in the database and then call out to Finances Interface to create an account through the CreateFulfillmentAccount.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can, be applied, alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

In this document, the term “module” or “component” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

In this document, the terms “computer program product”, “computer-readable medium”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), which when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

What is claimed is:

1. A method of managing a plurality of user accounts for using a storage delivery network, comprising:
creating a parent account;
creating a plurality of child accounts related to the parent account;
monitoring usage of the plurality of child accounts; and
billing the parent and child accounts in accordance with a billing policy set by the parent account.

2. The method of claim 1, wherein the billing policy provides that each child account is billed for its respective usage.

3. The method of claim 1, wherein the billing policy provides that the parent account is billed for the usage of the plurality of child accounts.

4. The method of claim 1, wherein the billing policy provides that the parent account is billed of a portion of the plurality of child accounts' usage.

5. The method of claim 1, further comprising setting an expiration time limit for at least one of the plurality of child accounts.

6. The method of claim 5, further comprising deleting all data associated with the at least one of the plurality of child accounts after expiration of expiration time limit.

7. The method of claim 1, further comprising setting a bandwidth limit for at least one of the plurality of child accounts, wherein the at least one child account having the bandwidth limit is prevented from exceeding the bandwidth limit.

8. The method of claim 1, further comprising creating a grandchild account related to one of the child accounts, wherein all policies of the related child account are automatically inherited by the grandchild account.

9. The method of claim 8, wherein the parent account, the plurality of child accounts and the grandchild account are related to one another in a hierarchical tree relationship.

10. The method of claim 1, wherein the parent account has access to the plurality of child accounts.

11. The method of claim 1, wherein each of the plurality of child accounts has a unique name space.

12. A method of tracking billing and usage of a plurality of accounts, the accounts comprising at least one parent account having a plurality of child accounts, the parent account having control of policies limiting the usage of the child accounts, comprising:
setting a billing policy of the child accounts using the parent account;
monitoring the usage of the child accounts;
determining costs associated with the usage;
billing the parent and child accounts in accordance with the billing policy.

13. The method of claim 12, further comprising setting usage limits of the child accounts using the parent account.

14. The method of claim 13, wherein each usage limit includes an expiration date.

15. The method of claim 14, further comprising marking a child account off-line after expiration of the expiration date.

16. The method of claim 15, further comprising deleting content of the child account after a predetermined time limit has been exceeded.

17. A method of managing accounts using a data file storage system, comprising:
creating a parent account;
creating a plurality of child accounts having a hierarchical relationship with the parent account;
setting billing policies for each of the plurality of child accounts using the parent account, the billing policies including rates relating to usage of the data file storage system;
billing each of the plurality of child accounts in accordance its respective billing policy.

18. The method of claim 17, wherein the parent account has access to the plurality of child accounts.

19. The method of claim 17, setting limits regarding usage of the plurality of child accounts using the parent account.

20. The method of claim 17, further comprising creating a grandchild account having a hierarchical relationship to one of the plurality of child accounts.

21. The method of claim 20, further comprising automatically setting a billing policy for grandchild account in accordance with billing policy of the child account from which the grandchild account is related.

22. The method of claim 17, further comprising retrieving real-time data on the plurality of child accounts using the parent account.

23. The method of claim 17, wherein the rates regarding the usage of the data file system are customizable by the parent account.

24. The method of claim 17, wherein the usage of the data file storage system includes usage of applications associated with the data file system.

25. The method of claim 17, wherein the usage of the data file system includes storing data files on the data file storage system, accessing data files on the data file storage system and performing media operations of data files stored in the data file storage system.

26. The method of claim 17, wherein the data file storage system is a storage delivery network (SDN).

27. A computer readable medium storing computer executable instructions that when executed perform a process for managing accounts of a file storage system, the instructions comprising:
a master account component;
a billing account component having an inheritance relationship with the master account component; and
a account component having an inheritance relationship with the billing account component,
wherein the master account component has the same functionality available to the billing account component and the account component.

28. The computer-readable medium of claim 27, wherein the master account component has tools to configure child accounts.

29. The computer-readable medium of claim 27, wherein the master account component is operable to view statistics relating to its child accounts.

30. The computer-readable medium of claim 27, wherein the master account component is operable to create and delete child accounts.
